(19) United States
(12) Patent Application Publication
(10) Pub. No.: US 2026/0303220 A1
(43) Pub. Date: Oct. 1, 2026

(54) OPTICAL TRANSMISSION DEVICE, OPTICAL TRANSMISSION SYSTEM, OPTICAL MODULE, AND OPTICAL CONTROLLER

(71) Applicant: 1FINITY Inc., Kawasaki-shi (JP)

(72) Inventors: Hiroki NAGATA, Fukuoka (JP); Junichi SUGIYAMA, Kawasaki (JP); Atsushi KANAI, Kawasaki (JP)

(73) Assignee: 1FINITY Inc., Kawasaki-shi (JP)

(21) Appl. No.: 19/571,111

(22) Filed: Mar. 18, 2026

(30) Foreign Application Priority Data
Mar. 31, 2025 (JP) 2025-059847

(51) Int. Cl. H04B 10/50; H04B 10/077; H04B 10/556; H04J 14/02

(52) U.S. Cl. CPC H04B 10/505; H04B 10/0775; H04B 10/5561; H04J 14/0307

(57) ABSTRACT

An optical transmission device includes a module and a controller. The module includes a communicator, a signal processor, and a configurator. The communicator transmits a third signal including a first signal having a first main signal and a second signal having monitoring information, and receives a sixth signal including a fourth signal having a second main signal and a fifth signal having setting information. The signal processor outputs the monitoring information, and processes the setting information. The configurator sets the setting information in the communicator. The controller includes a splitter, a collector, and a combiner. The splitter demultiplexes the first signal and the second signal from the module. The collector collects the monitoring information of the demultiplexed second signal, and collects the setting information obtained from the monitoring information. The combiner multiplexes the fifth signal including the collected setting information to the fourth signal.

### CROSS-REFERENCE TO RELATED APPLICATION

This application is based upon and claims the benefit of priority of the prior Japanese Patent Application No. 2025-059847, filed on Mar. 31, 2025, the entire contents of which are incorporated herein by reference.

### FIELD

The embodiments discussed herein are related to an optical transmission device, an optical transmission system, an optical module, and an optical controller.

### BACKGROUND

In recent years, for example, IP over DWDM (IPoDWDM) that enables direct transmission of IP data using the dense wavelength division multiplexing (DWDM) transmission technology has been known.

FIG. 10 is an explanatory diagram illustrating an example of a conventional optical transmission system 200. The optical transmission system 200 illustrated in FIG. 10 is an IPoDWDM optical transmission system. The optical transmission system 200 includes a station 210, an optical line system 220, an IP controller 230, and an optical transmission controller 240.

The station 210 is connected to a client-side terminal device via an electrical line, and is connected to the optical line system 220 via an optical line. For example, the optical line system 220 is a relay device that connects between the station 210 and an optical line on the opposite side.

The station 210 includes a router 211, an optical module 212, and an optical multiplexing/demultiplexing device 213. The router 211 is an electrical component connected to a client-side terminal device via an electrical line, and that transmits and receives electrical signals in IP packets to and from the terminal device.

The optical module 212 is an optical transceiver with a photoelectric conversion function that is electrically connected to the router 211 through a connector, and that is connected to the optical multiplexing/demultiplexing device 213 via an optical line. The optical module 212 optically converts an IP packet from the router 211, and outputs the optically converted optical signal to the optical multiplexing/demultiplexing device 213. The optical module 212 also electrically converts an optical signal from the optical multiplexing/demultiplexing device 213, and outputs the electrically converted IP packet to the router 211.

The optical multiplexing/demultiplexing device 213 connects the optical module 212 and the optical line system 220 via an optical line, and demultiplexes the optical signal from the optical line system 220. The optical multiplexing/demultiplexing device 213 outputs the demultiplexed optical signal to the optical module 212, multiplexes the optical signal from each optical module 212, and outputs the multiplexed optical signal to the optical line system 220.

The IP controller 230 is a controller that controls electrical components such as the router 211 in the station 210. The optical transmission controller 240 is a controller that controls optical components such as the optical multiplexing/demultiplexing device 213 and the optical line system 220.

For example, to set the wavelength to be used by the main signal in the optical module 212, the optical transmission controller 240 outputs the set wavelength of the optical module 212 via the IP controller 230 and the router 211. As a result, the optical module 212 receives the set wavelength via the router 211, and sets the received set wavelength as the wavelength to be used by the main signal. On the basis of the set wavelength that has been set, the optical module 212 can transmit and receive the optical signal of the main signal. The related technologies are described, for example, in: Japanese Laid-open Patent Publication No. 2016-152498, Japanese Laid-open Patent Publication No. 2007-274694, U.S. Patent Application Publication No. 2018/0013719, and U.S. Patent Application Publication No. 2017/0155462.

However, the optical transmission controller 240 needs to work with the IP controller 230, because the optical module 212 is controlled via the IP controller 230 and the router 211. As a result, the electrical components such as the router 211 are managed by the IP controller 230, and the optical components such as the optical multiplexing/demultiplexing device 213 are managed by the optical transmission controller 240. Hence, in reality, the electrical components and the optical components are not separately managed with respect to the optical module 212.

Thus, for example, to separately manage the electrical components and the optical components, independent control software may be incorporated in the router 211, if the router 211 and the optical module 212 are from the same vendor, so as to separately manage the electrical components and the optical components with respect to the optical module 212. However, the control method of the optical module 212 differs from vendor to vendor. Hence, if the vendors of the router 211 and the optical module 212 are different, there is a need to incorporate independent control software according to the optical module 212. Therefore, it is very difficult to separately manage the electrical components and the optical components with respect to the optical module. Thus, an optical transmission system that can separately manage the electrical components and the optical components with respect to the optical module, that is, that can control the optical module from an optical line side has been sought after.

### SUMMARY

According to an aspect of an embodiment, an optical transmission device includes an optical module and an optical controller. The optical module that includes a communicator, a signal processor and a configurator. The communicator is configured to transmit a third optical signal including a first optical signal having a first main signal and a second optical signal having monitoring information using an optical line, and to receive a sixth optical signal including a fourth optical signal having a second main signal and a fifth optical signal having setting information for digital coherent communication using an optical line. The signal processor is configured to output the monitoring information to the communicator, and to process the setting information from the communicator. The configurator is configured to set the setting information from the signal processor in the communicator. The optical controller includes a splitter, a collector and a combiner. The splitter is configured to demultiplex the first optical signal and the second optical signal from the third optical signal. The collector is configured to collect the monitoring information demultiplexed by the splitter, and to collect the setting information. The combiner is configured to multiplex the fifth optical signal including the setting information collected by the collector, to the fourth optical signal to be output to the optical module.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of an optical transmission system in a first embodiment;

FIG. 2 is an explanatory diagram illustrating an example of a station in the first embodiment;

FIG. 3 is an explanatory diagram illustrating an example of an optical module in the first embodiment;

FIG. 4 is an explanatory diagram illustrating an example of a functional block of an optical transmission device in the first embodiment;

FIG. 5 is an explanatory diagram illustrating an example of an optical transmission system in a second embodiment;

FIG. 6 is an explanatory diagram illustrating an example of a functional block of an optical transmission device in the second embodiment;

FIG. 7 is an explanatory diagram illustrating an example of an optical transmission system in a comparative example;

FIG. 8 is an explanatory diagram illustrating an example of an optical module in the comparative example;

FIG. 9 is an explanatory diagram illustrating an example of a station in the comparative example; and

FIG. 10 is an explanatory diagram illustrating an example of a conventional optical transmission system.

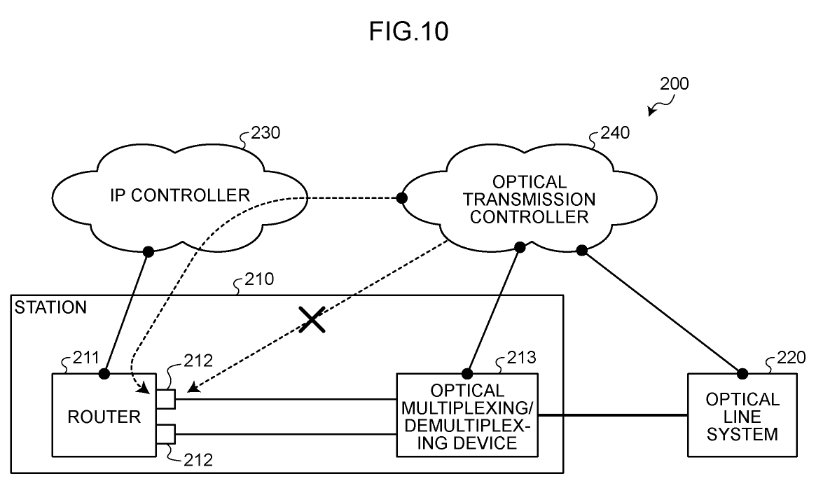

### DESCRIPTION OF EMBODIMENTS

In the conventional optical transmission system 200, the optical transmission controller 240 controls the optical module 212 via the IP controller 230 and the router 211. Thus, an optical transmission system 100 in a comparative example capable of managing the optical module as an optical component by separately managing the electrical components and the optical components, that is, capable of directly controlling the optical module from the optical line side has been sought after.

### Comparative Example

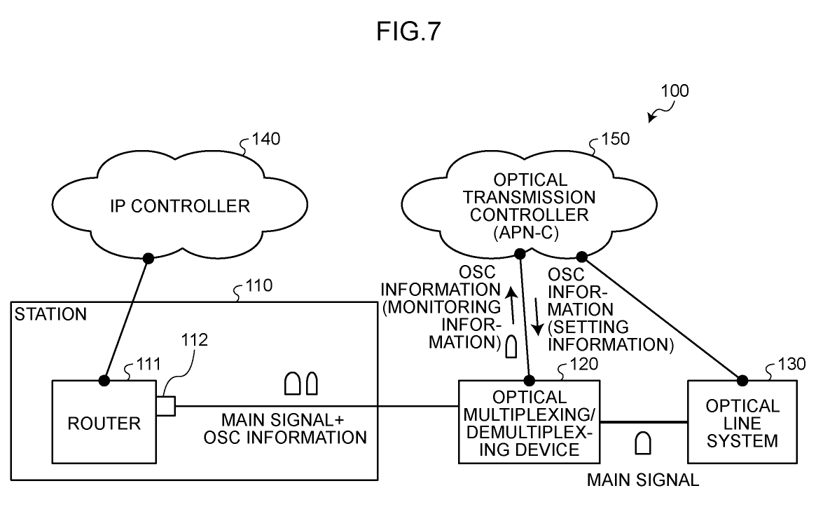

FIG. 7 is an explanatory diagram illustrating an example of an optical transmission system 100 in a comparative example. The optical transmission system 100 illustrated in FIG. 7 is an IPoDWDM optical transmission system. The optical transmission system 100 includes a station 110, an optical multiplexing/demultiplexing device 120, an optical line system 130, an IP controller 140, and an optical transmission controller 150.

The station 110 is connected to a client-side terminal device via an electrical line, and is connected to the optical multiplexing/demultiplexing device 120 via an optical line. The optical multiplexing/demultiplexing device 120 connects between an optical module 112 in the station 110 and the optical line system 130 via an optical line.

For example, the optical multiplexing/demultiplexing device 120 is an All Photonics Network-Gateway (APN-G) for Innovative Optical and Wireless Network (IOWN). The APN-G is a gateway for an optical path. The optical multiplexing/demultiplexing device 120 demultiplexes the optical signal from the optical line system 130, and outputs the demultiplexed optical signal to the optical module 112. The optical multiplexing/demultiplexing device 120 also multiplexes the optical signal from each optical module 112, and outputs the multiplexed optical signal to the optical line system 130. For example, the optical line system 130 is a relay device that connects between the station 110 and an optical line on the opposite side.

The station 110 includes a router 111 and the optical module 112. The router 111 is an electrical component connected to a client-side terminal device via an electrical line, and that transmits and receives electrical signals in IP packets to and from the terminal device.

The optical module 112 is an optical transceiver with a photoelectric conversion function that is electrically connected to the router 111 through a connector, and that is connected to the optical multiplexing/demultiplexing device 120 via an optical line. For example, the optical module 112 is an All Photonics Network-Transceiver (APN-T) for IOWN that transmits and receives a first optical signal of the main signal and a second optical signal of control information at different wavelengths. The APN-T is the termination point of the optical path. The optical module 112 optically converts an IP packet from the router 111, and outputs the optically converted optical signal to the optical multiplexing/demultiplexing device 120. The optical module 112 also electrically converts an optical signal from the optical multiplexing/demultiplexing device 120, and outputs the electrically converted IP packet to the router 111.

The IP controller 140 is a controller that controls electrical components such as the router 111 in the station 110. The optical transmission controller 150 is a controller that controls optical components such as the optical module 112, the optical multiplexing/demultiplexing device 120, and the optical line system 130. For example, the optical transmission controller 150 is an All Photonics Network-Controller (APN-C). The optical transmission controller 150 transmits the optical signal of the control information for controlling the optical module 112, to the optical multiplexing/demultiplexing device 120.

The optical multiplexing/demultiplexing device 120 multiplexes the second optical signal of the control signal from the optical transmission controller 150 to the first optical signal of the main signal addressed to the optical module 112, and transmits the multiplexed first optical signal of the main signal and the second optical signal of the control information, to the optical module 112. As a result, the optical module 112 performs a control operation on the basis of the control information.

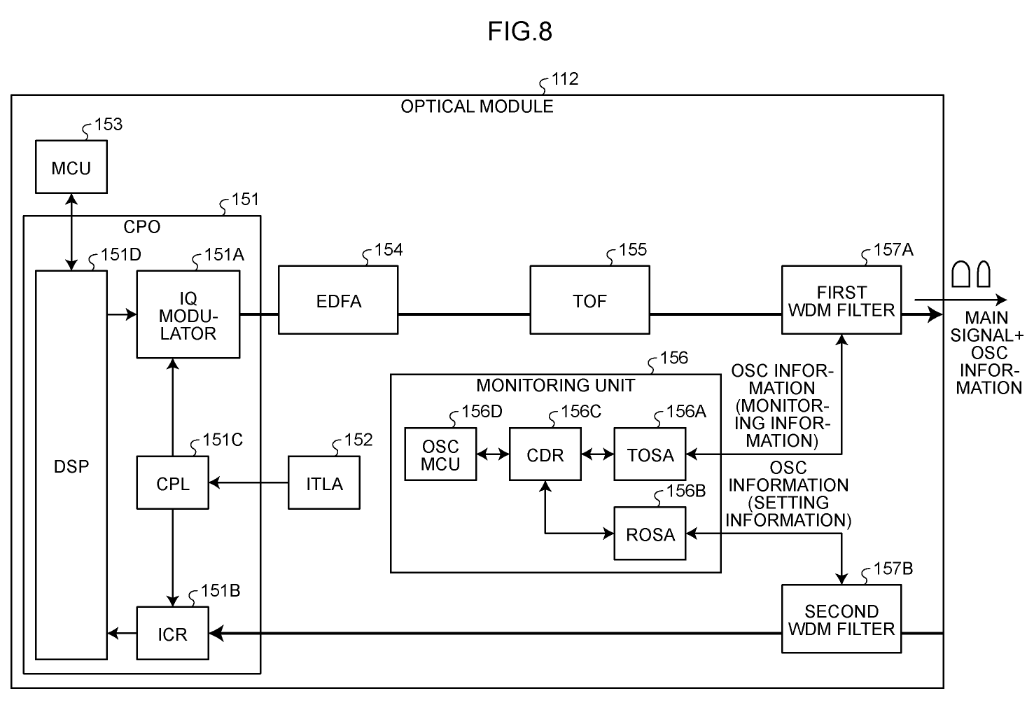

FIG. 8 is an explanatory diagram illustrating an example of the optical module 112 in the comparative example. The optical module 112 illustrated in FIG. 8 includes a co-packaged-optics (CPO) 151, an integrable tunable laser assembly (ITLA) 152, a micro controller unit (MCU) 153, and an erbium doped fiber amplifier (EDFA) 154. Moreover, the optical module 112 includes a tunable optical filter (TOF) 155, a monitoring unit 156, a first wavelength division multiplexing (WDM) filter 157A, and a second WDM filter 157B.

The CPO 151 is an optical component that performs signal processing on a main signal. The ITLA 152 is a light source that emits local light. The MCU 153 controls the entire optical module 112. The EDFA 154 is an optical fiber that amplifies the first optical signal of the main signal output from the CPO 151. The TOF 155 is a filter that filters the first optical signal of the optically amplified main signal.

The CPO 151 includes an IQ modulator 151A, an intradyne coherent receiver (ICR) 151B, a coupler (CPL) 151C, and a digital signal processor (DSP) 151D. The IQ modulator 151A is an optical modulator for digital coherent that modulates the main signal to a first optical signal using IQ modulation that is to be transmitted, on the basis of local light. The ICR 151B is an optical receiver that receives the first optical signal of the main signal that is received, on the basis of local light. The monitoring unit 156 is an OSC monitoring unit that outputs the second optical signal of the control information that is an optical supervisory channel (OSC), and that inputs the second optical signal including the control information of the OSC. The control information includes monitoring information indicating the status of the optical module 112, and setting information indicating the contents set in the optical module 112.

The optical transmission controller 150 obtains the monitoring information of the optical module 112 from the optical module 112 via the optical multiplexing/demultiplexing device 120, and generates setting information of the optical module 112, on the basis of the obtained monitoring information. The optical transmission controller 150 transmits the generated setting information to the optical module 112 via the optical multiplexing/demultiplexing device 120.

The first WDM filter 157A is a WDM filter that multiplexes the first optical signal of the main signal to be transmitted and the second optical signal of the OSC, and that outputs the multiplexed optical signal to the optical multiplexing/demultiplexing device 120. The second WDM filter 157B is a WDM filter that separates the first optical signal of the main signal and the second optical signal of the OSC, from the optical signal received from the optical multiplexing/demultiplexing device 120.

The monitoring unit 156 includes a transmitter optical sub-assembly (TOSA) 156A, a receiver optical sub-assembly (ROSA) 156B, clock data recovery (CDR) 156C, and an OSCMCU 156D. The OSCMCU 156D controls the entire monitoring unit 156. The OSCMCU 156D generates monitoring information in the control information of the optical module 112, and sets the setting information in the control information of the optical module 112. The CDR 156C superimposes the monitoring information in the control information on the OSC, and extracts the setting information in the control information from the OSC.

The TOSA 156A is an optical transmission function that converts the OSC including the monitoring information in the control information into a second optical signal, and that outputs the converted second optical signal to the first WDM filter 157A. The ROSA 156B is an optical reception function that converts the second optical signal of the OSC including the setting information in the control information input from the second WDM filter 157B, into an electrical signal.

The OSCMCU 156D generates monitoring information in the control information to be transmitted to the optical transmission controller 150, and outputs the generated monitoring information to the CDR 156C. The CDR 156C superimposes the monitoring information on the OSC, and outputs the OSC including the monitoring information to the TOSA 156A. The TOSA 156A optically converts the OSC including the monitoring information into the second optical signal of the OSC including the monitoring information, and outputs the optically converted second optical signal of the OSC including the monitoring information to the first WDM filter 157A.

The first WDM filter 157A multiplexes the second optical signal of the OSC including the monitoring information to the first optical signal of the main signal from the IQ modulator 151A, and outputs the multiplexed optical signal to the optical multiplexing/demultiplexing device 120. Then, the optical multiplexing/demultiplexing device 120 transparently outputs the first optical signal of the main signal to the optical line system 130, and separately outputs the second optical signal of the OSC including the monitoring information to the optical transmission controller 150. As a result, the optical transmission controller 150 extracts the monitoring information from the second optical signal of the OSC including the monitoring information, and generates setting information of the optical module 112, on the basis of the extracted monitoring information.

The optical transmission controller 150 converts the generated setting information into the second optical signal of the OSC including the generated setting information, and outputs the converted second optical signal of the OSC including the setting information to the optical multiplexing/demultiplexing device 120. The optical multiplexing/demultiplexing device 120 multiplexes the second optical signal of the OSC including the setting information, to the first optical signal of the main signal addressed to the optical module 112 from the optical line system 130, and outputs the multiplexed optical signal to the optical module 112.

The second WDM filter 157B in the optical module 112 separates the first optical signal of the main signal and the second optical signal of the OSC, from the optical signal from the optical multiplexing/demultiplexing device 120. The second WDM filter 157B outputs the first optical signal of the main signal to the ICR 151B, and outputs the second optical signal of the OSC to the ROSA 156B in the monitoring unit 156. The ROSA 156B converts the second optical signal of the OSC including the setting information into an electrical signal, and outputs the converted electrical signal of the OSC including the setting information to the CDR 156C. The CDR 156C separates the setting information from the electrical signal of the OSC including the setting information, and outputs the separated setting information to the OSCMCU 156D. The OSCMCU 156D sets the setting information in the MCU 153. As a result, the MCU 153 sets the setting information in the CPO 151.

In the optical transmission system 100 in the comparative example, the optical transmission controller 150 can control the optical module 112 as an optical component via the optical multiplexing/demultiplexing device 120. As a result, theoretically, the optical transmission controller 150 is capable of managing the optical module 112 as an optical component, while separately managing the electrical components.

However, unlike conventional optical modules, the optical module 112 for APN-T has a wavelength transmission/reception control function. Hence, from the viewpoint of heat, power, size, and the like, it is difficult to reduce the size of a form factor such as octal small form-factor pluggable (OSFP) and QSFP. Therefore, the mainstream form factor of the optical module 112 for APN-T is a C form-factor pluggable 2 (CFP2). In contrast, the mainstream form factor supported by the router 111 is QSFP.

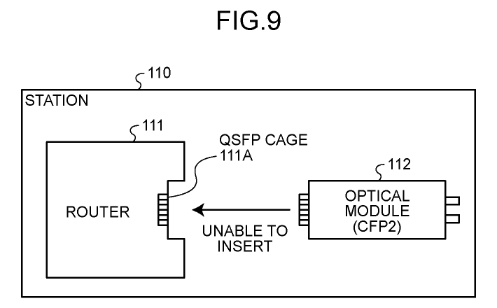

FIG. 9 is an explanatory diagram illustrating an example of the station 110 in the comparative example. The station 110 includes the router 111 and the optical module 112. The form factor of the optical module 112 is a C form-factor pluggable 2 (CFP2), and the form factor of the router 111 is a QSFP cage 111A. Therefore, at present, it is not possible to insert the optical module 112 into the QSFP cage 111A of the router 111 and connect through a connector.

Thus, to deal with such a situation, an embodiment of an optical transmission device that includes an optical module that enables transceiver control from the optical line side, while connecting to the router through a connector will be described. The disclosed technology is not limited to the present embodiment. Moreover, the following embodiments may be combined as appropriate within a range that does not contradict each other.

### a. First Embodiment

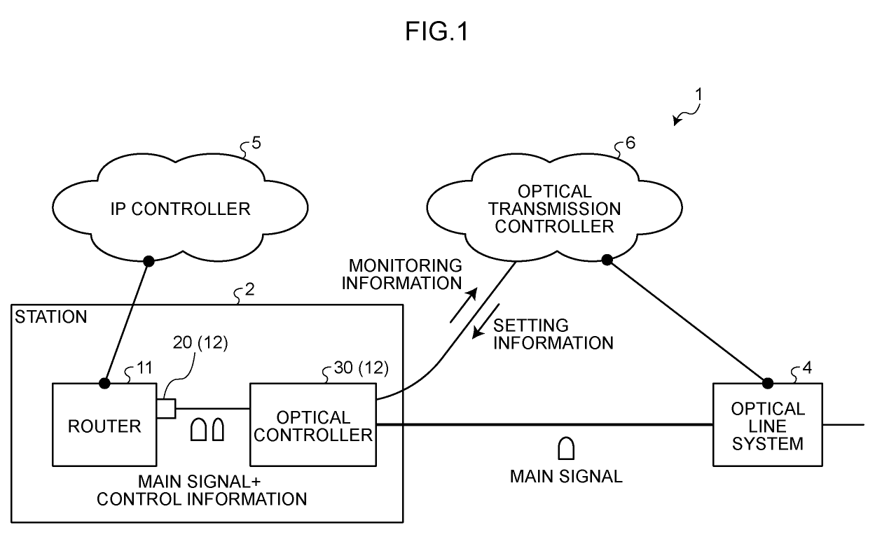

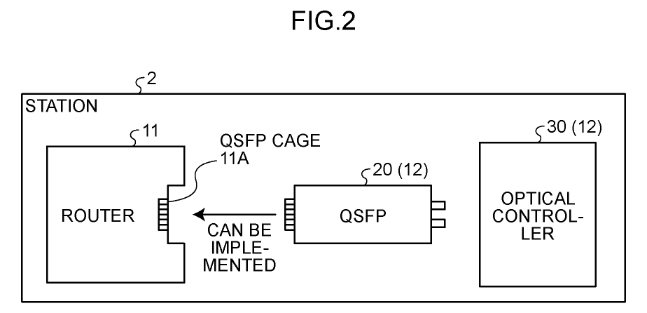

FIG. 1 is an explanatory diagram illustrating an example of an optical transmission system 1 in a first embodiment. FIG. 2 is an explanatory diagram illustrating an example of a station 2 in the first embodiment. The optical transmission system 1 illustrated in FIG. 1 is an IPoDWDM optical transmission system. The optical transmission system 1 includes the station 2, an optical line system 4, an IP controller 5, and an optical transmission controller 6.

The station 2 is connected to a client-side terminal device via an electrical line, and is connected to the optical line system 4 via an optical line. The station 2 includes a router 11 and an optical transmission device 12. The router 11 is a QSFP electrical component connected to a client-side terminal device via an electrical line, and that transmits and receives electrical signals in IP packets to and from the terminal device.

The optical transmission device 12 includes an optical module 20 and an optical controller 30. The optical module 20 is an optical transceiver with a photoelectric conversion function that is electrically connected to the router 11 through a connector, and that is optically connected to the optical line system 4. The optical module 20 transmits and receives the first optical signal of the main signal and the second optical signal of the control information at different wavelengths (for example, light label). The form factor of the optical module 20 is a QSFP cage 11A of a QSFP form factor, and can be connected to the router 11 through a connector. The optical module 20 optically converts an IP packet from the router 11, and outputs the optically converted optical signal to the optical controller 30. The optical module 20 also electrically converts an optical signal from the optical controller 30, and outputs the electrically converted IP packet to the router 11.

The optical controller 30 connects between the optical module 20 and the optical line system 4 via an optical line, and also connects between the optical module 20 and the optical transmission controller 6. The optical controller 30 transmits the first optical signal of the main signal via an optical line between the optical module 20 and the optical line system 4, transmits the second optical signal of the control information via an optical line from the optical module 20, and transmits a signal to the optical transmission controller 6 by aggregating control information. The transmission between the optical controller 30 and the optical transmission controller 6 is not limited to optical transmission. The control information is information used to control the optical module 20, related to the optical signal to be used for digital coherent communication. For example, the control information includes monitoring information indicating the status of the optical module 20, and setting information indicating the contents set in the optical module 20.

For example, the monitoring information is status information of the optical module 20 used for setting the optical signal to be used for digital coherent communication such as optical performance monitoring information, packet statistics, and the presence of an alarm. For example, the optical performance monitoring information corresponds to an optical signal to noise ratio (OSNR), a Q value, and the like. For example, the setting information is information for setting an optical signal to be used for digital coherent communication such as wavelength information related to the set wavelength of the first optical signal used for the main signal, modulation information related to modulation, power information related to optical power, and information related to a data rate.

The optical controller 30 demultiplexes the second optical signal including the monitoring information in the control information and the first optical signal including a first main signal, from a third optical signal from the optical module 20. The optical controller 30 multiplexes a fifth optical signal including the setting information in the control information from the optical transmission controller 6, and a fourth optical signal including a second main signal addressed to the optical module 20 from the optical line system 4, and outputs a sixth optical signal.

For example, the optical line system 4 is a relay device that connects between the station 2 and an optical line on the opposite side that is connected to a station and a relay device on the opposite side. The IP controller 5 is a controller of a layer 3 that controls electrical components such as the router 11 in the station 2. The optical transmission controller 6 is a controller of a layer 0 and a layer 1 that controls optical components such as the optical transmission device 12 and the optical line system 4. The optical transmission controller 6 transmits control information for controlling the optical module 20, to the optical module 20. As a result, the optical module 20 performs a control operation on the basis of the control information.

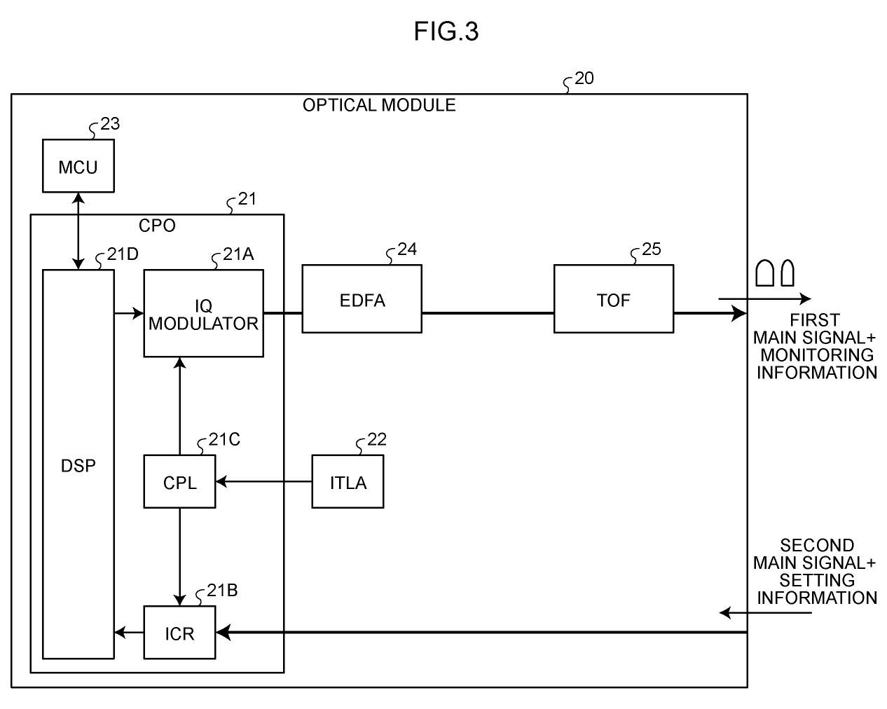

FIG. 3 is an explanatory diagram illustrating an example of the optical module 20 in the first embodiment. The optical module 20 illustrated in FIG. 3 includes a CPO 21, an ITLA 22, an MCU 23, an EDFA 24, and a TOF 25. The CPO 21 is an optical component that performs signal processing on the main signal. The ITLA 22 is a light source that emits local light. The MCU 23 controls the entire optical module 20. The EDFA 24 is an optical fiber that amplifies the first optical signal including the first main signal output from the CPO 21. The TOF 25 is a filter that filters the first optical signal including the optically amplified first main signal. The MCU 23 generates monitoring information in the control information of the optical module 20, and sets the setting information in the control information of the optical module 20 from the optical transmission controller 6, in the CPO 21.

The CPO 21 includes an IQ modulator 21A, an ICR 21B, a CPL 21C, and a DSP 21D. The IQ modulator 21A is an optical modulator for digital coherent that modulates the first optical signal including the first main signal using IQ modulation that is to be transmitted, on the basis of local light. The ICR 21B is an optical receiver that receives the fourth optical signal including the second main signal that is received, on the basis of local light.

The DSP 21D generates a first main signal and monitoring information in the control information to be transmitted to the optical transmission controller 6, and outputs the generated first main signal and monitoring information to the IQ modulator 21A. The IQ modulator 21A modulates the first main signal and the monitoring information to optical signals using IQ modulation, and outputs the first optical signal including the first main signal and the second optical signal including the monitoring information, to the optical transmission controller 6.

The DSP 21D extracts the second main signal from the fourth optical signal and the setting information from the fifth optical signal that are demodulated from the ICR 21B, and outputs the extracted setting information to the MCU 23. The MCU 23 sets the extracted setting information in the CPO 21.

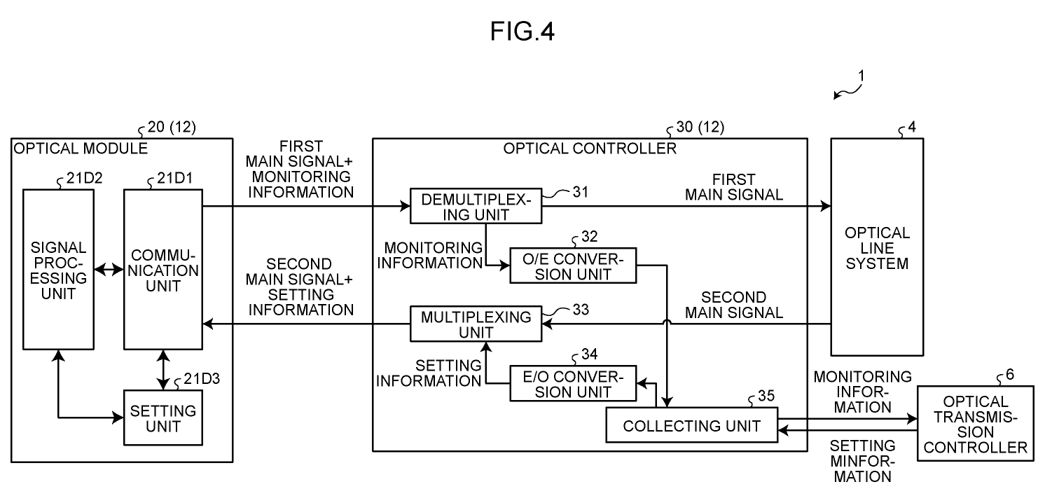

FIG. 4 is an explanatory diagram illustrating an example of a functional block of the optical transmission device 12 in the first embodiment. As functions, the optical module 20 includes a communication unit 21D1, a signal processing unit 21D2, and a setting unit 21D3. For example, the communication unit 21D1 is a function such as the IQ modulator 21A and the DSP 21D that transmits the third optical signal including the first optical signal having the first main signal and the second optical signal having the monitoring information for digital coherent communication using an optical line. For example, the communication unit 21D1 is a function such as the ICR 21B and the DSP 21D that receives the sixth optical signal including the fourth optical signal having the second main signal and the fifth optical signal having the setting information for digital coherent communication using an optical line. For example, the signal processing unit 21D2 is a function such as the DSP 21D that outputs the monitoring information related to the communication unit 21D1 in the control information, and that inputs the setting information in the control information. By using the IQ modulator 21A, the signal processing unit 21D2 outputs the first optical signal including the first main signal, and the second optical signal including the monitoring information in the control information, to the optical controller 30. By using the ICR 21B, the signal processing unit 21D2 receives the fourth optical signal including the second main signal and the fifth optical signal including the setting information in the control information, from the optical controller 30. For example, the setting unit 21D3 sets the received setting information in the control information in the IQ modulator 21A, the ICR 21B, or the like, in the CPO 21.

As functions, the optical controller 30 includes a demultiplexing unit 31, an O/E conversion unit 32, a multiplexing unit 33, an E/O conversion unit 34, and a collecting unit 35. The demultiplexing unit 31 demultiplexes the first optical signal including the first main signal and the second optical signal including the monitoring information, from the third optical signal from the optical module 20. The demultiplexing unit 31 transmits the separated first optical signal including the first main signal to the optical line system 4. Moreover, the demultiplexing unit 31 outputs the separated second optical signal including the monitoring information to the O/E conversion unit 32. The O/E conversion unit 32 electrically converts the second optical signal including the monitoring information, and outputs the electrically converted monitoring information to the collecting unit 35.

The collecting unit 35 collects the electrically converted monitoring information, and outputs the collected monitoring information to the optical transmission controller 6. On the basis of the monitoring information of the optical module 20, the optical transmission controller 6 generates setting information to be set in the optical module 20, and outputs the generated setting information to the collecting unit 35 in the optical controller 30.

The collecting unit 35 collects the setting information addressed to the optical module 20 that is received from the optical transmission controller 6, and outputs the collected setting information to the E/O conversion unit 34. The E/O conversion unit 34 optically converts the collected setting information into the fifth optical signal including the setting information, and outputs the optically converted fifth optical signal including the setting information to the multiplexing unit 33.

The multiplexing unit 33 multiplexes the fourth optical signal including the second main signal addressed to the optical module 20 from the optical line system 4, and the fifth optical signal including the setting information addressed to the optical module 20 from the E/O conversion unit 34, and outputs the multiplexed sixth optical signal to the optical module 20.

By using the ICR 21B, the communication unit 21D1 in the optical module 20 demodulates the first main signal from the first optical signal and the setting information from the second optical signal from the optical controller 30, and outputs the demodulated setting information to the setting unit 21D3 via the signal processing unit 21D2. Then, the setting unit 21D3 sets the setting information in the communication unit 21D1 in the CPO 21. As a result, the optical transmission system 1 can control the optical module 20 in the optical transmission device 12 from the optical line side.

The optical module 20 in the optical transmission device 12 in the first embodiment includes the signal processing unit 21D2 that outputs the monitoring information related to the communication unit 21D1 in the control information to the optical controller 30, and that inputs the setting information in the control information from the optical controller 30. Moreover, the optical module 20 includes the setting unit 21D3 that sets the setting information in the communication unit 21D1. As a result, it is possible to control the optical module 20 from the optical line side via the optical controller 30. In other words, it is possible to separately manage the electrical components and the optical components with respect to the optical module 20.

The optical controller 30 includes the demultiplexing unit 31 that demultiplexes the first optical signal and the second optical signal from the optical module 20, and the collecting unit 35 that collects the monitoring information in the demultiplexed second optical signal and that collects the setting information generated on the basis of the collected monitoring information. Moreover, the optical controller 30 includes the multiplexing unit 33 that multiplexes the fifth optical signal including the setting information collected by the collecting unit 35, to the fourth optical signal to be output to the optical module 20, and that outputs the multiplexed fourth optical signal and fifth optical signal to the optical module 20. As a result, it is possible to control the optical module 20 from the optical line side.

The optical controller 30 only terminates the second optical signal including the monitoring information, without terminating the first optical signal including the first main signal. The optical module 20 can be controlled from the optical line side by communicating control information with the optical controller 30. As a result, the optical module 20 can be controlled from the optical line side, without going through the router 11.

The optical module 20 is a QSFP optical module. As a result, the optical module 20 can be connected to the mainstream router 11 through a connector.

The setting information includes at least one of wavelength information, modulation information, power information and a data rate related to the optical signal to be used for digital coherent communication. As a result, the optical module 20 can control the setting information related to the optical signal to be used for digital coherent communication, from the optical line side.

The monitoring information includes at least one of optical performance monitoring information, packet statistics information, and the presence of an alarm related to the optical signal to be used for digital coherent communication. As a result, the optical module 20 can transmit the monitoring information related to the optical signal to be used for digital coherent communication, to the optical transmission controller 6 from the optical line side.

With the optical module 20, the monitoring unit 156, the first WDM filter 157A, and the second WDM filter 157B in the optical module 112 in the comparative example are no longer needed. Hence, the size of the optical module 20 can be reduced than that of the optical module 112 in the comparative example. As a result, it is possible to implement the optical module 20 reduced in size that can be connected to the router 11 through a connector.

With the optical module 20, for example, it is possible to implement the minimum communication function on the optical line side among the control functions from the optical line side, such as the communication function of the main signal and the function for setting the setting information in the control function. Moreover, with the optical controller 30, it is possible to implement a high layer function that allows communication with the optical transmission controller 6 by generating monitoring information and setting information to be used for communication with the outside or the like.

The multiplexing unit 33 and the demultiplexing unit 31 may also be configured with couplers, and appropriate modifications may be made.

The optical transmission system 1 in the first embodiment includes the optical module 20 and the optical controller 30 on a one-to-one basis. However, it is not limited to thereto, and the optical transmission system 1 may also include a plurality or N pieces of optical modules 20 and a single optical controller 30 on an N-to-one basis. The embodiment will be described below as a second embodiment.

### b. Second Embodiment

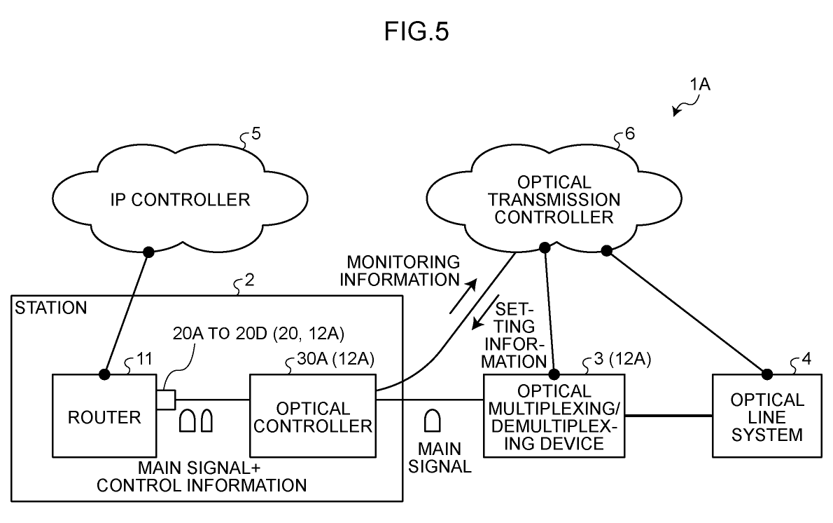

FIG. 5 is an explanatory diagram illustrating an example of an optical transmission system 1A in a second embodiment. The same reference numerals denote the same components as those in the optical transmission system 1 in the first embodiment, and descriptions of overlapping components and operations will be omitted. The optical transmission system 1A in the second embodiment is different from the optical transmission system 1 in the first embodiment in that a plurality of, for example, four optical modules 20A to 20D (20) are connected to a single optical controller 30A.

An optical transmission device 12A includes the four optical modules 20A to 20D, the single optical controller 30A, and an optical multiplexing/demultiplexing device 3. It is assumed that the optical module 20A uses first wavelength λ1, to transmit and receive the first optical signal including the first main signal and the fourth optical signal including the second main signal. It is assumed that the optical module 20B uses second wavelength λ2, to transmit and receive the first optical signal including the first main signal and the fourth optical signal including the second main signal. It is assumed that the optical module 20C uses third wavelength λ3, to transmit and receive the first optical signal including the first main signal and the fourth optical signal including the second main signal. It is assumed that the optical module 20D uses fourth wavelength λ4, to transmit and receive the first optical signal including the first main signal and the fourth optical signal including the second main signal.

The optical multiplexing/demultiplexing device 3 is disposed on the optical line between the optical controller 30A and the optical line system 4. The optical multiplexing/demultiplexing device 3 multiplexes the first optical signal of each optical module 20 from the optical controller 30A, and outputs the multiplexed first optical signal to the optical line system 4. The optical multiplexing/demultiplexing device 3 multiplexes each first optical signal including the first main signal at λ1 to λ4, and outputs the multiplexed first optical signal of the first main signal at λ1 to λ4 to the optical line system 4.

The optical multiplexing/demultiplexing device 3 demultiplexes the fourth optical signal from the optical line system 4 for each optical module 20, and outputs the demultiplexed fourth optical signal to the optical module 20. Upon receiving the fourth optical signal including the second main signal at λ1, the optical multiplexing/demultiplexing device 3 outputs the fourth optical signal including the second main signal at λ1 to the optical module 20A. Upon receiving the fourth optical signal including the second main signal at λ2, the optical multiplexing/demultiplexing device 3 outputs the fourth optical signal including the second main signal at λ2 to the optical module 20B. Upon receiving the fourth optical signal including the second main signal at λ3, the optical multiplexing/demultiplexing device 3 outputs the fourth optical signal including the second main signal at λ3 to the optical module 20C. Upon receiving the fourth optical signal including the second main signal at λ4, the optical multiplexing/demultiplexing device 3 outputs the fourth optical signal including the second main signal at λ4 to the optical module 20D.

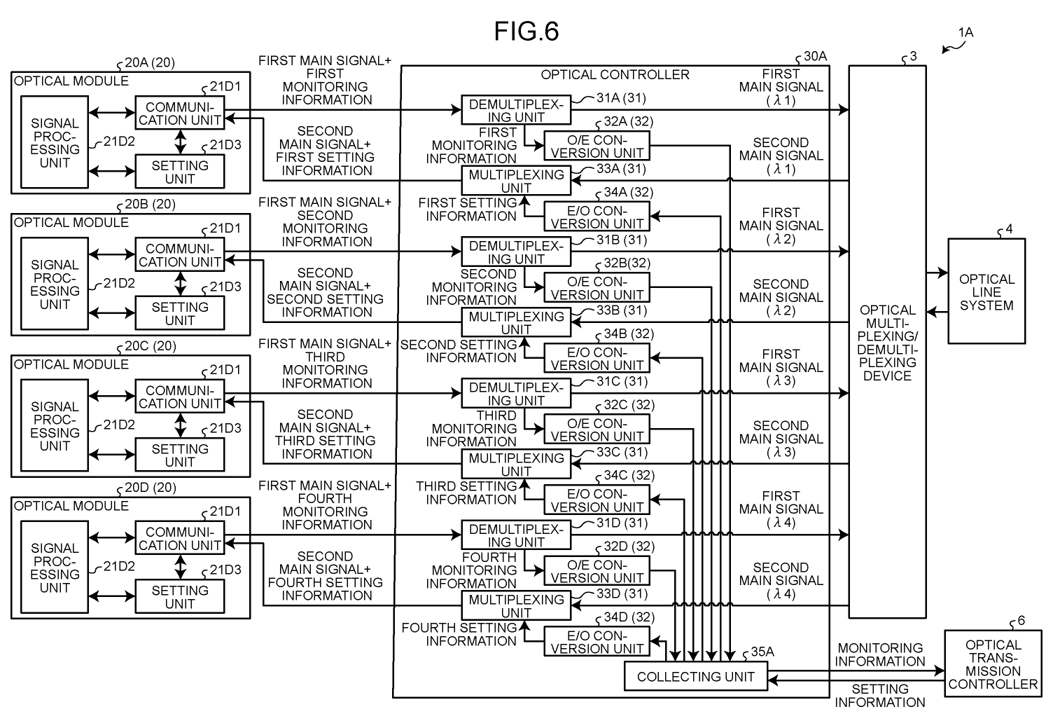

FIG. 6 is an explanatory diagram illustrating an example of a functional block of the optical transmission device 12A in the second embodiment. The optical controller 30A includes first demultiplexing unit 31A to fourth demultiplexing unit 31D provided in each of the optical modules 20A to 20D that demultiplex the first optical signal and the second optical signal from the third optical signal from the optical modules 20A to 20D. Moreover, the optical controller 30A includes first multiplexing unit 33A to fourth multiplexing unit 33D provided in each of the optical modules 20A to 20D that multiplex the fifth optical signal including the collected setting information, to the fourth optical signal to be output to the optical modules 20A to 20D.

The optical multiplexing/demultiplexing device 3 multiplexes the first optical signal from each of the demultiplexing units 31A to 31D provided in each of the optical modules 20A to 20D, and outputs the multiplexed first optical signal to a counter device. The optical multiplexing/demultiplexing device 3 demultiplexes the fourth optical signal to be input to each of the multiplexing units 33A to 33D provided in each of the optical modules 20A to 20D, from the fourth optical signal from the counter device.

As functions, the optical controller 30A includes the first demultiplexing unit 31A, a first O/E conversion unit 32A, the first multiplexing unit 33A, and a first E/O conversion unit 34A. As functional units, the optical controller 30A includes the second demultiplexing unit 31B, a second O/E conversion unit 32B, the second multiplexing unit 33B, and a second E/O conversion unit 34B. As functional units, the optical controller 30A includes the third demultiplexing unit 31C, a third O/E conversion unit 32C, the third multiplexing unit 33C, and a third E/O conversion unit 34C. As functional units, the optical controller 30A includes the fourth demultiplexing unit 31D, a fourth O/E conversion unit 32D, the fourth multiplexing unit 33D, a fourth E/O conversion unit 34D, and a collecting unit 35A.

The first demultiplexing unit 31A separates the first optical signal including the first main signal and the second optical signal including first monitoring information, from the third optical signal at λ1 from the optical module 20A. The first monitoring information is the monitoring information related to the digital coherent communication of the optical module 20A. The first demultiplexing unit 31A transmits the separated first optical signal including the first main signal to the optical multiplexing/demultiplexing device 3. Moreover, the first demultiplexing unit 31A outputs the separated second optical signal including the first monitoring information to the first O/E conversion unit 32A. The first O/E conversion unit 32A electrically converts the second optical signal of the first monitoring information, and outputs the electrically converted first monitoring information to the collecting unit 35A.

The collecting unit 35A collects the electrically converted first monitoring information, and outputs the collected first monitoring information to the optical transmission controller 6. On the basis of the first monitoring information of the optical module 20A, the optical transmission controller 6 generates first setting information to be set in the optical module 20A, and outputs the generated first setting information to the collecting unit 35A in the optical controller 30A. The first setting information is the setting information to be used for digital coherent communication of the optical module 20A.

The collecting unit 35A collects the first setting information addressed to the optical module 20A received from the optical transmission controller 6, and outputs the collected first setting information to the first E/O conversion unit 34A. The first E/O conversion unit 34A optically converts the first setting information, and outputs the fifth optical signal including optically converted the first setting information to the first multiplexing unit 33A.

The first multiplexing unit 33A multiplexes the fourth optical signal including the second main signal addressed to the optical module 20A from the optical line system 4, and the fifth optical signal including the first setting information addressed to the optical module 20 from the first E/O conversion unit 34A, and outputs the multiplexed sixth optical signal to the optical module 20A.

The communication unit 21D1 in the optical module 20A demodulates the second main signal and the first setting information from the sixth optical signal from the optical controller 30A using the ICR 21B, and outputs the demodulated first setting information to the setting unit 21D3 via the signal processing unit 21D2. Then, the setting unit 21D3 sets the first setting information in the CPO 21. As a result, with the optical module 20A, transceiver control from the optical line side is accomplished.

The second demultiplexing unit 31B separates the first optical signal including the first main signal and the second optical signal including the second monitoring information, from the third optical signal at λ2 from the optical module 20B. The second monitoring information is the monitoring information related to the digital coherent communication of the optical module 20B. The second demultiplexing unit 31B transmits the separated first optical signal including the first main signal to the optical multiplexing/demultiplexing device 3. Moreover, the second demultiplexing unit 31B outputs the separated second optical signal including the second monitoring information to the second O/E conversion unit 32B. The second O/E conversion unit 32B electrically converts the second optical signal including the second monitoring information, and outputs the electrically converted second monitoring information to the collecting unit 35A.

The collecting unit 35A collects the electrically converted second monitoring information, and outputs the collected second monitoring information to the optical transmission controller 6. On the basis of the second monitoring information of the optical module 20B, the optical transmission controller 6 generates second setting information to be set in the optical module 20B, and outputs the generated second setting information to the collecting unit 35A in the optical controller 30A. The second setting information is the setting information to be used for digital coherent communication of the optical module 20B.

The collecting unit 35A collects the second setting information addressed to the optical module 20B received from the optical transmission controller 6, and outputs the collected second setting information to the second E/O conversion unit 34B. The second E/O conversion unit 34B optically converts the second setting information, and outputs the optically converted second setting information to the second multiplexing unit 33B.

The second multiplexing unit 33B multiplexes the fourth optical signal including the second main signal addressed to the optical module 20B from the optical line system 4, and the fifth optical signal including the second setting information addressed to the optical module 20B from the second E/O conversion unit 34B, and outputs the multiplexed sixth optical signal to the optical module 20B.

The communication unit 21D1 in the optical module 20B demodulates the second main signal and the second setting information from the sixth optical signal from the optical controller 30A using the ICR 21B, and outputs the demodulated second setting information to the setting unit 21D3 via the signal processing unit 21D2. Then, the setting unit 21D3 sets the second setting information in the CPO 21. As a result, with the optical module 20B, transceiver control from the optical line side is accomplished.

The third demultiplexing unit 31C separates the first optical signal including the first main signal and the second optical signal including the third monitoring information, from the third optical signal at λ3 from the optical module 20C. The third monitoring information is the monitoring information related to the digital coherent communication of the optical module 20C. The third demultiplexing unit 31C transmits the separated first optical signal including the first main signal to the optical multiplexing/demultiplexing device 3. Moreover, the third demultiplexing unit 31C outputs the separated second optical signal including the third monitoring information to the third O/E conversion unit 32C. The third O/E conversion unit 32C electrically converts the second optical signal including the third monitoring information, and outputs the electrically converted third monitoring information to the collecting unit 35A.

The collecting unit 35A collects the electrically converted third monitoring information, and outputs the collected third monitoring information to the optical transmission controller 6. On the basis of the third monitoring information of the optical module 20C, the optical transmission controller 6 generates third setting information to be set in the optical module 20C, and outputs the generated third setting information to the collecting unit 35A in the optical controller 30A. The third setting information is the setting information to be used for digital coherent communication of the optical module 20C.

The collecting unit 35A collects the third setting information addressed to the optical module 20C received from the optical transmission controller 6, and outputs the collected third setting information to the third E/O conversion unit 34C. The third E/O conversion unit 34C optically converts the third setting information, and outputs the optically converted third setting information to the third multiplexing unit 33C.

The third multiplexing unit 33C multiplexes the fourth optical signal including the second main signal addressed to the optical module 20C from the optical line system 4, and the fifth optical signal including the third setting information addressed to the optical module 20C from the third E/O conversion unit 34C, and outputs the multiplexed sixth optical signal to the optical module 20C.

The communication unit 21D1 in the optical module 20C demodulates the second main signal and the third setting information from the sixth optical signal from the optical controller 30A using the ICR 21B, and outputs the demodulated third setting information to the setting unit 21D3 via the signal processing unit 21D2. Then, the setting unit 21D3 sets the third setting information in the CPO 21. As a result, with the optical module 20C, transceiver control from the optical line side is accomplished.

The fourth demultiplexing unit 31D separates the first optical signal including the first main signal and the second optical signal including the fourth monitoring information, from the third optical signal at λ4 from the optical module 20D. The fourth monitoring information is the monitoring information related to the digital coherent communication of the optical module 20D. The fourth demultiplexing unit 31D transmits the separated first optical signal including the first main signal to the optical multiplexing/demultiplexing device 3. Moreover, the fourth demultiplexing unit 31D outputs the separated second optical signal including the fourth monitoring information to the fourth O/E conversion unit 32D. The fourth O/E conversion unit 32D electrically converts the second optical signal including the fourth monitoring information, and outputs the electrically converted fourth monitoring information to the collecting unit 35A.

The collecting unit 35A collects the electrically converted fourth monitoring information, and outputs the collected fourth monitoring information to the optical transmission controller 6. On the basis of the fourth monitoring information of the optical module 20D, the optical transmission controller 6 generates fourth setting information to be set in the optical module 20D, and outputs the generated fourth setting information to the collecting unit 35A in the optical controller 30A. The fourth setting information is the setting information to be used for digital coherent communication of the optical module 20D.

The collecting unit 35A collects the fourth setting information addressed to the optical module 20D received from the optical transmission controller 6, and outputs the collected fourth setting information to the fourth E/O conversion unit 34D. The fourth E/O conversion unit 34D optically converts the fourth setting information, and outputs the optically converted fourth setting information to the fourth multiplexing unit 33D.

The fourth multiplexing unit 33D multiplexes the fourth optical signal including the second main signal addressed to the optical module 20D from the optical line system 4, and the fifth optical signal including the fourth setting information addressed to the optical module 20D from the fourth E/O conversion unit 34D, and outputs the multiplexed sixth optical signal to the optical module 20D.

The communication unit 21D1 in the optical module 20D demodulates the second main signal and the fourth setting information from the sixth optical signal from the optical controller 30A using the ICR 21B, and outputs the demodulated fourth setting information to the setting unit 21D3 via the signal processing unit 21D2. Then, the setting unit 21D3 sets the fourth setting information in the CPO 21. As a result, with the optical module 20D, transceiver control from the optical line side is accomplished.

The optical module 20A in the optical transmission device 12A in the second embodiment includes the signal processing unit 21D2 that outputs the first monitoring information related to the communication unit 21D1 in the control information to the optical controller 30A, and that inputs the first setting information in the control information from the optical controller 30A. The optical module 20A includes the setting unit 21D3 that sets the first setting information in the communication unit 21D1. As a result, the optical transmission controller 6 can control the optical module 20A from the optical line side via the optical controller 30A. In other words, it is possible to separately manage the electrical components and the optical components with respect to the optical module 20A.

The optical module 20B includes the signal processing unit 21D2 that outputs the second monitoring information related to the communication unit 21D1 in the control information to the optical controller 30A, and that inputs the second setting information in the control information from the optical controller 30A. The optical module 20B includes the setting unit 21D3 that sets the second setting information in the communication unit 21D1. As a result, the optical transmission controller 6 can control the optical module 20B from the optical line side via the optical controller 30A. In other words, it is possible to separately manage the electrical components and the optical components with respect to the optical module 20B.

The optical module 20C includes the signal processing unit 21D2 that outputs the third monitoring information related to the communication unit 21D1 in the control information to the optical controller 30A, and that inputs the third setting information in the control information from the optical controller 30A. The optical module 20C includes the setting unit 21D3 that sets the third setting information in the communication unit 21D1. As a result, the optical transmission controller 6 can control the optical module 20C from the optical line side via the optical controller 30A. In other words, it is possible to separately manage the electrical components and the optical components with respect to the optical module 20C.

The optical module 20D includes the signal processing unit 21D2 that outputs the fourth monitoring information related to the communication unit 21D1 in the control information to the optical controller 30A, and that inputs the fourth setting information in the control information from the optical controller 30A. The optical module 20D includes the setting unit 21D3 that sets the fourth setting information in the communication unit 21D1. As a result, the optical transmission controller 6 can control the optical module 20D from the optical line side via the optical controller 30A. In other words, it is possible to separately manage the electrical components and the optical components with respect to the optical module 20D.

The optical controller 30A includes the first demultiplexing unit 31A to the fourth demultiplexing unit 31D that demultiplex the first optical signal and the second optical signal from the optical modules 20A to 20D. The optical controller 30A includes the collecting unit 35 that collects the monitoring information in the demultiplexed second optical signal, and that collects the setting information generated on the basis of the collected monitoring information. The optical controller 30A includes the first multiplexing unit 33A to the fourth multiplexing unit 33D that multiplex the fifth optical signal including the collected setting information, to the fourth optical signal to be output to the optical modules 20A to 20D, and that output the multiplexed fourth optical signal and the fifth optical signal to the optical modules 20A to 20D. As a result, the optical transmission controller 6 can control the optical modules 20A to 20D from the optical line side.

In the station 2 in the optical transmission system 1 of the first embodiment, a set of the optical module 20 and the optical controller 30 is made on a one-to-one basis. However, it is not limited thereto, and there may also be a plurality of sets of the optical module 20 and the optical controller 30 made on a one-to-one basis, and appropriate modifications may be made.

In the optical transmission system 1 in the first embodiment, a single optical module 20 is connected to each router 11. However, a plurality of the optical modules 20 may also be connected to each router 11, and appropriate modifications may be made.

Moreover, the EDFA 24 is exemplified as the optical amplifier. However, the optical amplifier is not limited to the EDFA 24, and for example, a semiconductor optical amplifier (SOA) or the like may also be used, and appropriate modifications may be made.

Furthermore, the components of the illustrated units need not be physically configured as illustrated. In other words, the specific mode of dispersion and integration of each unit is not limited to those illustrated in the drawings, and all or part of the units may be functionally or physically distributed or integrated in any unit according to various loads, usage conditions, and the like.

According to one aspect, there is provided an optical transmission device that can control the optical module from the optical line side.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical transmission device comprising:
an optical module that includes
a communicator configured to transmit a third optical signal including a first optical signal having a first main signal and a second optical signal having monitoring information using an optical line, and to receive a sixth optical signal including a fourth optical signal having a second main signal and a fifth optical signal having setting information for digital coherent communication using an optical line,
a signal processor configured to output the monitoring information to the communicator, and process the setting information from the communicator, and
a configurator configured to set the setting information from the signal processor in the communicator; and
an optical controller that includes
a splitter configured to demultiplex the first optical signal and the second optical signal from the third optical signal,
a collector configured to collect the monitoring information demultiplexed by the splitter, and collect the setting information, and
a combiner configured to multiplex the fifth optical signal including the setting information collected by the collector, to the fourth optical signal to be output to the optical module.

2. The optical transmission device according to claim 1, wherein the optical module is a quad small form-factor pluggable (QSFP) optical module.

3. The optical transmission device according to claim 1, wherein the setting information includes wavelength information, modulation information, power information, a data rate related to an optical signal to be used for the digital coherent communication, or any combination thereof.

4. The optical transmission device according to claim 1, wherein the monitoring information includes at least one of optical performance monitoring information, packet statistics information, presence of an alarm related to an optical signal to be used for the digital coherent communication, or any combination thereof.

5. The optical transmission device according to claim 1, wherein
the optical controller includes
a plurality of the optical modules,
the splitter provided in each of the optical modules, and configured to demultiplex the first optical signal and the second optical signal from the third optical signal from each of the optical modules, and
the combiner provided in each of the optical modules, and configured to multiplex the fifth optical signal including the setting information collected by the collector, to the fourth optical signal to be output to the optical module, and
the optical transmission device includes an optical multiplexing/demultiplexing device configured to multiplex the first optical signal from each splitter provided in each of the optical modules and output the multiplexed first optical signal to a counter device, and configured to demultiplex the fourth optical signal to be input to each combiner provided in each of the optical modules, from each fourth optical signal from the counter device.

6. An optical transmission system comprising:
an optical module that includes
a communicator configured to transmit a third optical signal including a first optical signal having a first main signal and a second optical signal having monitoring information using an optical line, and receive a sixth optical signal including a fourth optical signal having a second main signal and a fifth optical signal having setting information using an optical line,
a monitor configured to output the monitoring information to the communicator, and input the setting information, and
a configurator configured to set the setting information from the communicator;
an optical controller that includes
a splitter configured to demultiplex the first optical signal and the second optical signal from the third optical signal,
a collector configured to collect the monitoring information demultiplexed by the splitter, and collect the setting information, and
a combiner configured to multiplex the fifth optical signal including the setting information collected by the collector, to the fourth optical signal to be output to the optical module; and
an optical transmission controller configured to obtain the monitoring information from the optical controller, generate the setting information based on the obtained monitoring information, and transmit the generated setting information to the optical controller.

7. An optical module comprising:
a communicator configured to transmit a third optical signal including a first optical signal having a first main signal and a second optical signal having monitoring information using an optical line, and receive a sixth optical signal including a fourth optical signal having a second main signal and a fifth optical signal having setting information for digital coherent communication using an optical line;
a signal processor configured to output the monitoring information, and process the setting information from the communicator; and
a configurator configured to set the setting information in the communicator.

8. An optical controller comprising:
a splitter configured to demultiplex a first optical signal including a first main signal and a second optical signal including monitoring information from a third optical signal from an optical module;
a collector configured to collect the monitoring information included in the second optical signal demultiplexed by the splitter, and collect setting information generated based on the collected monitoring information; and
a combiner configured to multiplex a fifth optical signal including the setting information to a fourth optical signal to be output to the optical module.
